(19) United States
(12) Patent Application Publication
(10) Pub. No.: US 2024/0402682 A1
(43) Pub. Date: Dec. 5, 2024

(54) SYSTEM AND METHOD OF FABRICATING CONDUITS IN A HEATED SYSTEM

(71) Applicant: Victor Cruz, Bartlett, TN (US)

(72) Inventor: Victor Cruz, Bartlett, TN (US)

(21) Appl. No.: 18/734,068

(22) Filed: Jun. 5, 2024

Related U.S. Application Data
(60) Provisional application No. 63/506,343, filed on Jun. 5, 2023.

(51) Int. Cl. G05B 19/418

(52) U.S. Cl. CPC G05B 19/418; G05B 2219/45148

(57) ABSTRACT

A method of forming conduits in a heated system structure is provided. The method includes forming a first structural component from a solid insulation material, the first structural component having at least a first side with a first slot formed thereon. Forming a second structural component from the solid insulation material, the second structural component having at least a second side with a second slot formed thereon. The first slot and the second slot are aligned. The first side is abutted to the second side. The first side is sealing coupled to the second side to form a unitary structural member, wherein the first slot and second slot cooperate to define an integral conduit.

### CROSS-REFERENCES TO RELATED APPLICATIONS

This application claims the benefit of U.S. Provisional Application No. 63/506,343, filed on Jun. 5, 2023. The entire content of the aforementioned application is incorporated herein by reference.

### BACKGROUND OF THE DISCLOSURE

The subject matter disclosed herein relates to a system and method for integrally fabricating conduits in a heated system, and in particular to forming conduits for a working fluid in a pool, spa or hot tub system.

Heated systems, such as pools, spas or hot tubs have conduits that transfer a working fluid, such as water for example through a housing. The working fluid transfers heat from a heating system the area where warm water is desired, such as the users are located via jets in the case of a spa or hot tub for example, or to a body of water in the case of a pool for example.

It should be appreciated that the conduits are often insulated to reduce heat loss between the heater and the use location. Conduits are made from pipes, such as plastic pipes (e.g. PVC) for example. These discrete pipes require fittings, such as to move around corners or at intersections for example. These fittings potentially leak over time and may also be costly and labor intensive to install. Further, because the pipes are insulated, the interface of the pipe and insulation material provides another potential source of heat loss.

While existing heated systems are suitable for their intended purposes the need for improvement remains, particularly in providing a heated system, such as a pool, spa or hot tub having the features described herein.

### BRIEF DESCRIPTION OF THE DISCLOSURE

According to one aspect of the disclosure a method of forming conduits in a heated system structure is provided. The method includes forming a first structural component from a solid insulation material, the first structural component having at least a first side with a first slot formed thereon. Forming a second structural component from the solid insulation material, the second structural component having at least a second side with a second slot formed thereon. The first slot and the second slot are aligned. The first side is abutted to the second side. The first side is sealing coupled to the second side to form a unitary structural member, wherein the first slot and second slot cooperate to define an integral conduit.

In addition to one or more of the features described herein, or as an alternative, further embodiments of the method may include the solid insulation material being a closed cell form material.

In addition to one or more of the features described herein, or as an alternative, further embodiments of the method may include the first structural component being a first portion of a wall and the second structural component is a second portion of a wall.

In addition to one or more of the features described herein, or as an alternative, further embodiments of the method may include the step of aligning the first slot to the second slot including arranging the first structural component vertically above the second structural component, wherein the first side and second side are horizontally parallel.

In addition to one or more of the features described herein, or as an alternative, further embodiments of the method may include the step of aligning the first slot to the second slot includes arranging the first structural component horizontally adjacent the second structural component, wherein the first side and second side are vertically parallel.

In addition to one or more of the features described herein, or as an alternative, further embodiments of the method may include the first structure component including a third slot formed on the first side and the second structural component includes a fourth slot formed on the second side.

In addition to one or more of the features described herein, or as an alternative, further embodiments of the method may include aligning the third slot with the fourth slot prior to sealingly coupling the first side to the second side.

In addition to one or more of the features described herein, or as an alternative, further embodiments of the method may include the third slot being perpendicular to the first slot and the fourth slot is perpendicular to the second slot.

In addition to one or more of the features described herein, or as an alternative, further embodiments of the method may include the third slot and the fourth slot cooperating to define a second integral conduit in the unitary member.

According to another aspect of the disclosure a method of forming conduits in a heated system structure is provided. The method includes forming a structural component of the heating system structure from a solid material. A directional boring machine is then used to form an integral passageway within the structural component.

In addition to one or more of the features described herein, or as an alternative, further embodiments of the method may include the directional boring machine being configured to bore a passageway around a corner.

In addition to one or more of the features described herein, or as an alternative, further embodiments of the method may include boring the integral passageway around a plurality of corners to define an integral conduit loop.

In addition to one or more of the features described herein, or as an alternative, further embodiments of the method may include the directional boring machine including a tool for removing the solid material from the structural component.

In addition to one or more of the features described herein, or as an alternative, further embodiments of the method may include the solid material being a closed cell foam material.

According to one aspect of the disclosure a system for forming conduits in a heated system structure. The system having a directional boring mechanism having a housing with a boring tool disposed on a first end, the tool configured to remove material from a wall of the heated system structure and dispose the material out a second opposite end of the housing. At least one processor is provided that is responsive to executable computer instructions for performing a method that includes forming an integral passageway within the wall.

In addition to one or more of the features described herein, or as an alternative, further embodiments of the system may include the directional boring mechanism having a sensor that is coupled to communicate with the at least one processor, the sensor having an inertial measurement unit.

In addition to one or more of the features described herein, or as an alternative, further embodiments of the system may include the directional boring mechanism having a vacuum operably coupled between the tool and the second end, the vacuum configured to remove debris generated by the tool.

In addition to one or more of the features described herein, or as an alternative, further embodiments of the system may include the directional boring mechanism further having a camera operably coupled to the housing with a field of view out the first end.

In addition to one or more of the features described herein, or as an alternative, further embodiments of the system may include the directional boring mechanism further having a propulsion system configured to move the directional boring mechanism through a passageway formed by the tool.

In addition to one or more of the features described herein, or as an alternative, further embodiments of the system may include the directional boring mechanism further having a power supply circuit having a battery disposed with the housing.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic view of a heated system such as a hot tub in accordance with an embodiment;

FIG. 2A is a partial section view of the housing of FIG. 1 with an integrally formed conduit according to an embodiment;

FIG. 2B is a partial section view of the housing of FIG. 1 with an integrally formed conduit according to another embodiment;

FIG. 2C is a partial section view of the housing of FIG. 1 with an integrally formed conduit according to yet another embodiment;

FIG. 2D is a partial section view of the housing of FIG. 2C according to an embodiment;

FIG. 3A is a schematic illustration of a method of forming an integral conduit in the housing of FIG. 1 at a first time in accordance with an embodiment;

FIG. 3B is a schematic illustration of a method of forming an integral conduit in the housing of FIG. 1 at a second time in accordance with an embodiment; and

FIG. 4 is a schematic illustration of a boring tool for forming the conduits of FIG. 3A and FIG. 3B in accordance with an embodiment.

The detailed description explains embodiments of the disclosure, together with advantages and features, by way of example with reference to the drawings.

### DETAILED DESCRIPTION OF THE DISCLOSURE

Embodiments of the present disclosure provide for a system and method of forming integral conduits in a heated system having insulated walls, such as a pool, spa or hot tub. Embodiments of the present disclosure provide for a method of forming integral conduits by forming the insulated walls in sections and fusing the sections together. Embodiments of the present disclosure provide for a method of forming integral conduits by boring the conduits into a solid wall fabricated at least in part by insulation material.

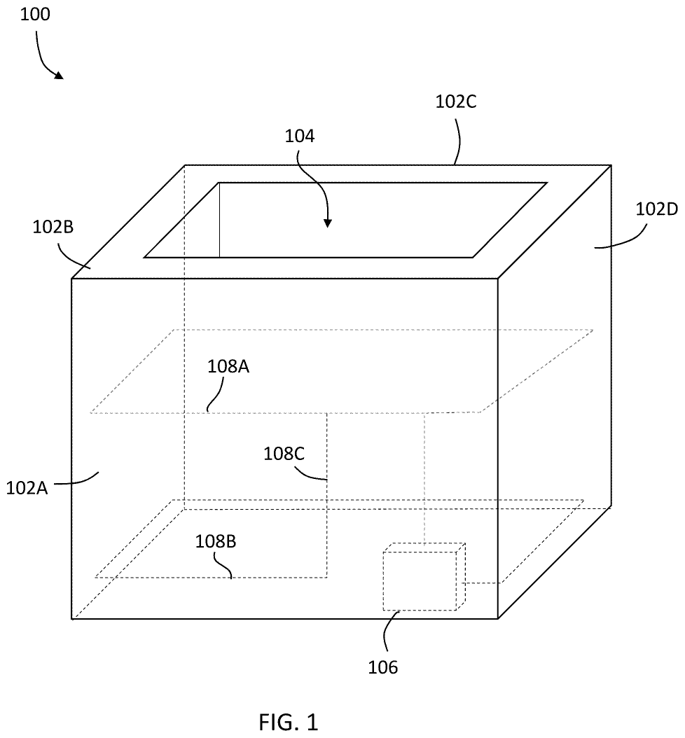

Referring now to FIG. 1, a heated system, such as a hot tub 100 for example, is shown. The hot tub 100 includes a plurality of walls 102A, 102B, 102C, 102D that define an interior space 104. The hot tub 100 may include a pump system 106 that may be disposed internal to the walls 102A, 102B, 102C, 102D or may located external to the walls. The pump 106 may include a heating system, or the heating system may be a separate component.

As will be discussed in more detail herein, arranged within the walls 102A, 102B, 102C, 102D that may include one or more integrally formed conduits 108A, 108B that transfer a working fluid, such a water for example, from the pump 106 to desired locations about the interior space 104. It should be appreciated that in an embodiment where the heated system is a spa or hot tub, the conduits may be coupled to nozzles (not shown) that inject the working fluid into the interior space 104. The conduits 108A, 108B may be formed as loops as shown or may be formed to define a direct fluid path from the pump 106 to the nozzles. The conduit loops 108A, 108B may optionally be fluidly coupled by integrally formed vertical conduits 108C.

As used herein, the conduits are “integrally formed” in the walls such that once the final wall is fabricated, the space to transfer the working fluid is unitary with the wall and does not utilize a fitting or other component to define the working fluid transfer passageway.

Referring now to FIG. 0.2A, an embodiment is shown of a wall 202 that is initially formed from two separate members 203A, 203B. The members 203A, 203B are made from a suitable insulation material, such as a closed cell foam material for example. In an embodiment, the foam insulation may be a closed cell low-density elastomer or polymer. Each wall member 203A, 203B is formed with one or more semicircular recesses or slots 210, 212 on a side 214, 216 that will face the opposing wall member. The slots 210, 212 are positioned to align when the sides 214, 216 are abutted against each other. In an embodiment, the slots 210, 212 define a circular passageway when the members are abutted. In other embodiments, the slots 210, 212 may define a noncircular passage way (e.g. an elliptical cross-section shape) to provide different flow characteristics.

The members 203A, 203B are joined in a manner to that couples the sides 214, 216 together structurally and also fluidly seals the passageway formed by the slots 210, 212 from the exterior surfaces 218A, 218B, 220A, 220B. The members 203A, 203B may be sealingly joined using a number of processes, such as by an adhesive, electrofusion, thermal fusion, or welding for example. It should be appreciated that while the sides 214, 216 are shown as being planar, this is for example purposes and the claims should not be so limited. In other embodiments, the sides 214, 216 may include features, such as keys for example, that facilitate alignment of the members 203A, 203B and may provide additional surface area for joining the members 203A, 203B.

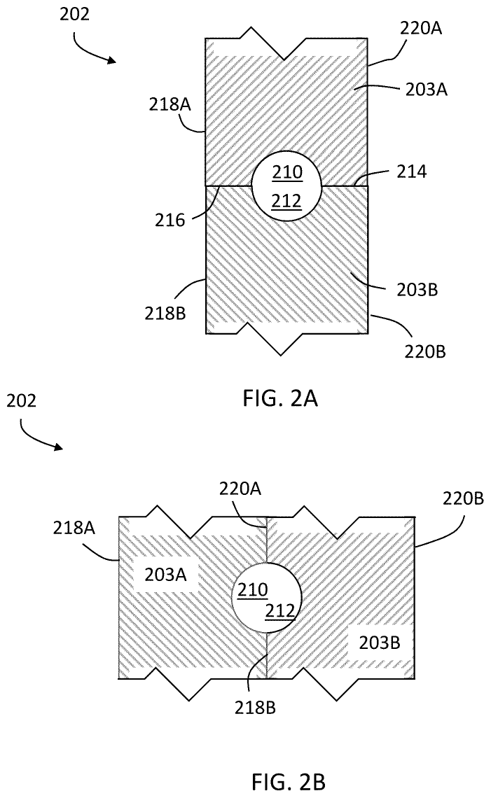

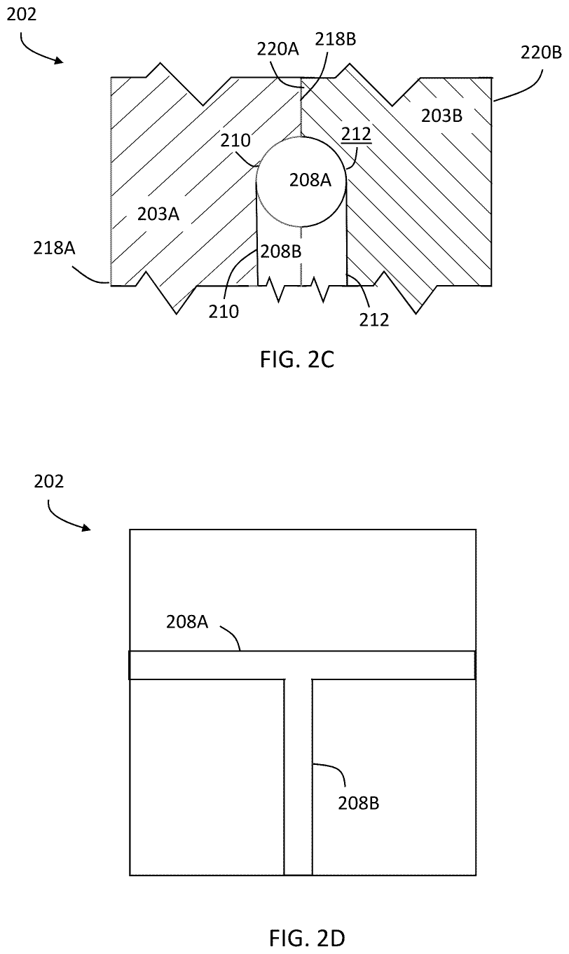

In the embodiment of FIG. 2A, the sides 214, 216 are configured to be horizontal relative to floor or surface on which the hot tub 100 is positioned. Referring now to FIG. 2B, an embodiment is shown having a vertically oriented coupling of surfaces 220A, 218B. In this embodiment, the slot 210 is formed in wall 220A of member 203A, and slot 212 is formed in wall 218B of member 203B. It should be appreciated that when the walls 220A, 218B are sealing joined, the slots 210, 212 define a passageway for transfer of the working fluid.

As discussed above, the conduits 108A, 108B may be coupled by vertical conduits 108C. The structure and methods discussed above may be used to simultaneously define both horizontal conduits (e.g. conduits 108A, 108B), and vertical conduits (e.g. conduit 108C). Referring now to FIG. 2C and FIG. 2D an embodiment is shown of a wall 202 having both a horizontal and a vertical passageway integrally formed therein. This embodiment is similar to the embodiment of FIG. 2B with the wall members 203A, 203B being sealingly joined side-by-side alongside walls 220A, 218B.

In this embodiment, the side walls 218B, 220A each further include an additional slots 222, 224 that intersects the slots 210, 212. In the illustrated embodiment, the slots 222, 224 are perpendicular to the passageway 208A defined by the slots 210, 212. The slots 224 are positioned to define a passageway 208C when the side walls 218B, 220A are sealingly joined.

It should be appreciated that while the embodiment of FIG. 2C and FIG. 2D illustrate the wall members 203A,203B as being sealingly joined with a vertical seal/coupling, this is for example purposes and the claims should not be so limited. In other embodiments a horizontal seal/coupling may be formed similar to FIG. 2A without deviating from the teachings provided herein.

Further, it should be appreciated that while embodiments herein illustrate the integrally formed passageways/conduits as being horizontal or vertical, this is for example purposes and the integrally formed passageways/conduits may be arranged on angles, both relative to the surface on which the hot tub rests, and each other.

It should further be appreciated that the outer and interior surfaces of the walls 200 may include an additional layer, such as an acrylic layer for example.

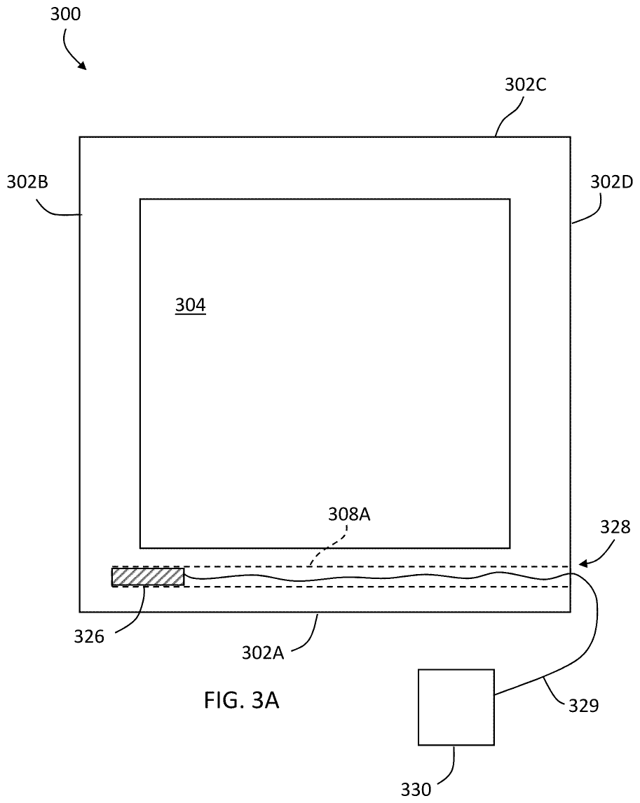

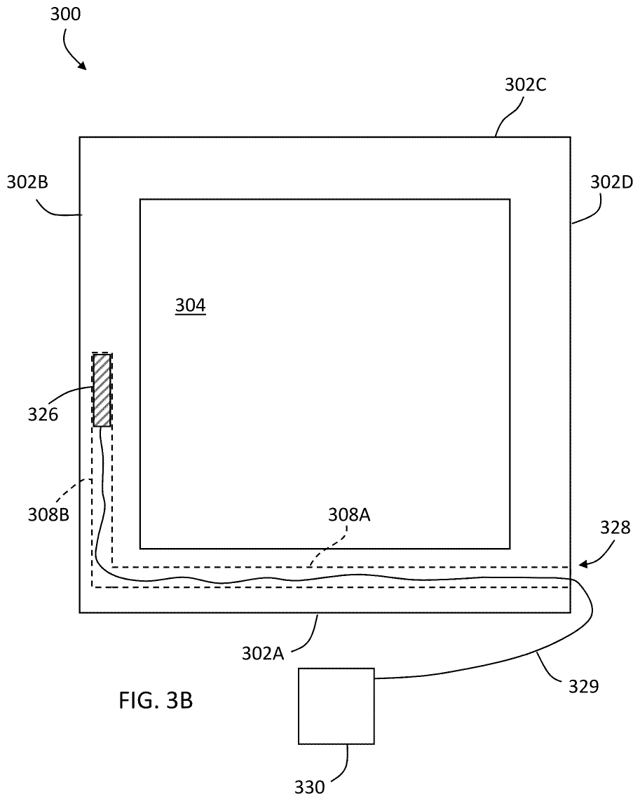

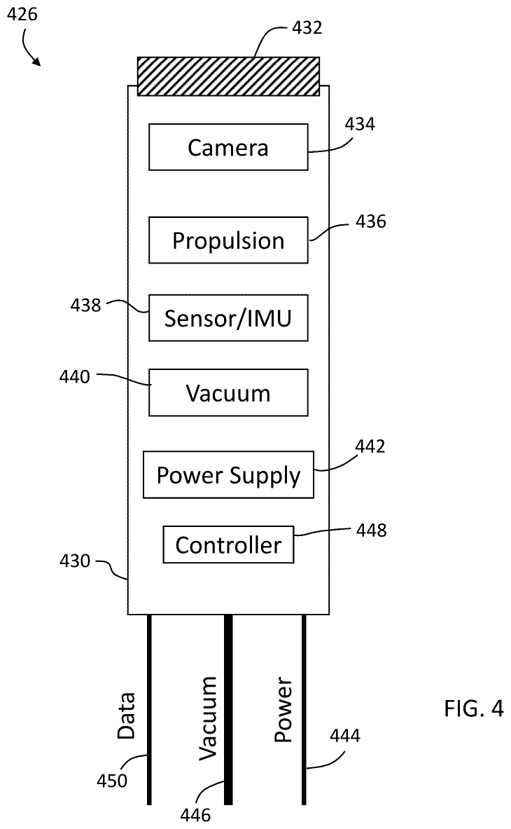

Referring now to FIG. 3A, FIG. 3B and FIG. 4, another embodiment of a system and method of forming integral conduits in walls of a heating system, such as hot tub 300 is shown. In this embodiment, the hot tub 300 includes a plurality of walls 302A, 302B, 302C, 302D that define an interior space 304. The walls 302A, 302B, 302C, 302D are made from an insulation material, such as a closed cell foam as described herein.

In this embodiment, to form the conduit 308A, a boring device 326 is used. As discussed in more detail herein, the boring device 326 includes a drill or grinding mechanism that is configured to cut and remove material within the walls 302A to integrally form the conduit. In an embodiment, such as shown in FIG. 3A, the device 326 is tunnels or bores from an exterior opening, such as opening 328 for example. The opening 328 may be later sealed, or alternatively closed with a removable cap to allow servicing. In an embodiment, an umbilical cable 329 is coupled to the device 326 and extends to a controller 330. In an embodiment, the umbilical transmits power to the device 326. In another embodiment, the umbilical 329 transmits power and data between the device 326 and the controller 330. In still a further embodiment, the umbilical 329 includes a vacuum line for extracting material bored out by the device 326.

It should be appreciated that as the device 326 proceeds in boring the conduit 308A, at a certain time, the device may reach a bend or corner of the hot tube 300. In an embodiment, the device 326 is configured to bore a conduit around a corner as is shown in FIG. 3B. In an embodiment, the device 326 may be referred to as a directional boring/drilling machine. It should be appreciated that once the device 326 proceeds about a corner, another segment 308B of the conduit may be integrally formed in the wall (e.g. wall 302B) without incorporating fittings or couplings as in prior art systems.

Referring now to FIG. 4, an embodiment is shown of the directional boring device 426 that may be used to integrally form conduits in a wall of a heating system, such as hot tub 100, 300 for example. The device 426 includes a housing 430 with a drill or boring tool 432 on one end. The tool 432 is configured to remove material from the wall and disposed on the material out a distal end of housing 430. The device 426 may optionally include a camera 434 that allows an operator to view the inside of the conduit. The device 426 may further include a propulsion system 436. A sensor system 438 is provided that provides feedback to a controller (e.g. controller 330) regarding the position of the device 426. In an embodiment, the sensor system 438 may be an inertial measurement unit that includes components such as accelerometers and a compass for example. The sensor system 438 allows the controller to operate the tool 432 and the propulsion device in a predetermined manner to generate the conduit in the desired location.

In an embodiment, the device 426 may optionally include a vacuum 440 that facilitates removal of the debris generated by the tool 432 and passes/transfers the material (e.g. via line/conduit 446) to an area outside of the hot tub 100, 300. The device 426 may further include a power supply 442 that adapts incoming power from power cable 444 to have suitable characteristics to the subsystems within the device 426. In an embodiment, the device 426 is battery operated and the power line 444 may be omitted. The device 426 may further include a controller 448 that communicates with an external computing device, such as control 330 for example. The controller 448 may transmit and receive data either wirelessly or via a cable 450. In an embodiment, the power line 444, the vacuum line 446, and the data line 450 are part of the umbilical 329.

It should be appreciated that while embodiments herein refer to integrally forming conduits in a wall of a heating system, this is for example purposes and the claims should not be so limited. In other embodiments, the system and methods described herein may be used to form conduits in any solid structure of the heating system, such as but not limited to the floor, bottom, top, or cover of the structure.

Further, while embodiments described herein may refer to the fluid being transferred through the conduits as being water, this is for example purposes and the claims should not be so limited. In other embodiments, the fluid may be a gas or a non-water liquid for example.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method of forming conduits in a heated system structure, the method comprising:
forming a first structural component from a solid insulation material, the first structural component having at least a first side with a first slot formed thereon;
forming a second structural component from the solid insulation material, the second structural component having at least a second side with a second slot formed thereon;
aligning the first slot and the second slot;
abutting the first side to the second side; and
sealingly coupling the first side to the second side to form a unitary structural member, wherein the first slot and second slot cooperate to define an integral conduit.

2. The method of claim 1, wherein the solid insulation material is a closed cell form material.

3. The method of claim 1, wherein the first structural component is a first portion of a wall and the second structural component is a second portion of a wall.

4. The method of claim 3, wherein the step of aligning the first slot to the second slot includes arranging the first structural component vertically above the second structural component, wherein the first side and second side are horizontally parallel.

5. The method of claim 3, wherein the step of aligning the first slot to the second slot includes arranging the first structural component horizontally adjacent the second structural component, wherein the first side and second side are vertically parallel.

6. The method of claim 1, wherein the first structure component includes a third slot formed on the first side and the second structural component includes a fourth slot formed on the second side.

7. The method of claim 6, further comprising aligning the third slot with the fourth slot prior to sealingly coupling the first side to the second side.

8. The method of claim 7, wherein the third slot is perpendicular to the first slot and the fourth slot is perpendicular to the second slot.

9. The method of claim 8, wherein the third slot and the fourth slot cooperate to define a second integral conduit in the unitary member.

10. A method of forming conduits in a heated system structure, the method comprising:
forming a structural component of the heating system structure from a solid material; and
using a directional boring machine forming an integral passageway within the structural component.

11. The method of claim 10, wherein the directional boring machine is configured to bore a passageway around a corner.

12. The method of claim 11, further comprising boring the integral passageway around a plurality of corners to define an integral conduit loop.

13. The method of claim 12, wherein the directional boring machine includes a tool for removing the solid material from the structural component.

14. The method of claim 12, wherein the solid material is a closed cell foam material.

15. A system for forming conduits in a heated system structure, the system comprising:
a directional boring mechanism having a housing with a boring tool disposed on a first end, the tool configured to remove material from a wall of the heated system structure and dispose the material out a second opposite end of the housing; and
at least one processor responsive to executable computer instructions for performing a method that includes forming an integral passageway within the wall.

16. The system of claim 15, wherein the directional boring mechanism includes a sensor that is coupled to communicate with the at least one processor, the sensor having an inertial measurement unit.

17. The system of claim 16, wherein the directional boring mechanism includes a vacuum operably coupled between the tool and the second end, the vacuum configured to remove debris generated by the tool.

18. The system of claim 16, wherein the directional boring mechanism further includes a camera operably coupled to the housing with a field of view out the first end.

19. The system of claim 18, herein the directional boring mechanism further includes a propulsion system configured to move the directional boring mechanism through a passageway formed by the tool.

20. The system of claim 19, wherein the directional boring mechanism further includes a power supply circuit having a battery disposed with the housing.
